(19) United States
(12) Patent Application Publication
(10) Pub. No.: US 2022/0031433 A1
(43) Pub. Date: Feb. 3, 2022

(54) Preliminary Product for the Production of Prosthetic Teeth and Method for the Production and Processing Thereof

(71) Applicant: Kulzer GmbH, Hanau (DE)

(72) Inventors: Lars Hendrik Diez, Hanau (DE); Stephan Dekert, Wehrheim (DE); Roger Ritzel, Biebergemünd (DE)

(21) Appl. No.: 17/277,185

(22) PCT Filed: Aug. 15, 2019
(86) PCT No.: PCT/EP2019/071922

§ 371 Date: Mar. 17, 2021

(30) Foreign Application Priority Data
Sep. 21, 2018 (DE) 10 2018 123 318.3

(51) Int. Cl. A61C 13/08; A61C 13/00

(52) U.S. Cl. CPC A61C 13/081; A61C 13/0022; A61C 13/0006; A61C 13/0004

(57) ABSTRACT

A preliminary product for the production of prosthetic teeth for a dental prosthesis, the preliminary product having a plurality of prefabricated prosthetic teeth and a mounting geometry, the prefabricated prosthetic teeth having a preformed coronal surface and a preformed circumferential surface which adjoins the coronal surface, the mounting geometry having at least one strut, wherein the at least one strut is embodied in one piece with at least one of the prefabricated prosthetic teeth, wherein the prefabricated prosthetic teeth are fixable in position with the mounting geometry in a mount of a CAM apparatus in such a way that the prefabricated prosthetic teeth are mechanically machinable with the CAM apparatus.

Also provided is a method for the production of such a preliminary product and to a method for the production of a dental prosthesis using a CAM method.

The invention relates to a preliminary product for the production of prosthetic teeth for a dental prosthesis. The invention also relates to a method for the production of such a preliminary product and to a method for the production of a dental prosthesis using a CAM method.

In addition to craft skills, digital manufacturing methods are also becoming increasingly significant in the dental sector. For several years, dental prostheses and other dental moldings, such as for example crowns, bridges, prosthetic bases for the production of dental prostheses, prosthetic teeth and 3-dimensional models of a patient's oral cavity, have been produced or machined by means of Computer-Aided Design/Computer-Aided Manufacturing (CAD/CAM) technologies using subtractive milling methods.

A CAD/CAM method for producing a dental prosthesis is known from WO 91/07141 A1, wherein, in this method, a prosthetic base is milled on the basis of an impression from a plastics material block.

There are methods, such as, for example, the methods known from DE 10 2009 056 752 A1 or WO 2013/124 452 A1, in which a partial or full dental prosthesis is waxed up digitally and produced by means of CAD/CAM methods. From the patent DE 103 04 757 B4, a method for producing dental prostheses is known in which the teeth are virtually waxed-up in a virtual model and a prosthetic base is produced on the basis of the virtual model. EP 2 742 906 A1 discloses a method in which a dental arch is connected to an impression composition, wherein the impression composition is held in an individualized impression tray and contains an impression of the situation in the patient's oral cavity. The surface of the mold with the dental arch is digitized and then a virtual model of the dental arch is computationally positioned and oriented with the best possible fit in the virtual model of the prosthetic base. WO 2016/091 762 A1 discloses a method for producing a dental prosthesis, in which a jig is produced with which a plurality of prosthetic teeth may be fastened in the desired location and orientation relative to one another on a prosthetic base. From the patent DE 103 04 757 B4, a method for producing dental prostheses is known in which the teeth are virtually waxed-up in a virtual model and a prosthetic base is produced on the basis of the virtual model. WO 2016/110 392 A1 discloses a method for producing a dental prosthesis, in which a plastically deformable connecting means is introduced into dental alveoli of a prosthetic base in order to enable manual correction of the orientation of the prosthetic teeth in the prosthetic base.

There are technical approaches to separating the data of the prosthetic base and of the teeth in the production of removable dental prostheses, such as full and partial dental prostheses, which were produced with the assistance of digital data using a CAD design. The prosthetic base may in this case be produced by a generative or also a subtractive manufacturing method. Suitable prosthetic teeth are prefabricated plastic teeth or also individually produced prosthetic teeth or dental arches made from the same starting materials. In any case, dental alveoli for accommodating these prosthetic teeth must be provided in the prosthetic base into which the prosthetic teeth or the dental arches are then fastened, for example by adhesive bonding, in a subsequent manual manufacturing step.

Methods for this purpose are known from EP 2 571 451 B1 and EP 2 666 438 A2, in which prefabricated prosthetic teeth are embedded in a wax mount and then milled away basally by means of CAM methods. The prosthetic teeth shortened in this manner are removed from the wax and then inserted in a prosthetic base and cemented in place therein in order to produce a dental prosthesis. One drawback of this is that the prosthetic teeth must have wax residues removed and be cleaned before they can be inserted into the prosthetic base. It is necessary to shorten the prosthetic teeth basally in order to adapt tooth height to the patient's jaw, i.e. to tailor the occlusal height of the dental prosthesis to the patient's requirements.

A dental prosthesis is known from CH 701 436 A2 in which a prosthetic tooth is fastened as bridge structure to the neighboring teeth using a rail. To this end, a feed-through is provided in the prosthetic tooth. Such prosthetic teeth are not intended for insertion into prosthetic bases and therefore are not suitable for the production of dental prostheses, since the feed-through through the prosthetic tooth would be disadvantageous in a dental prosthesis. U.S. Pat. No. 4,721,466 A discloses a set of prosthetic teeth, which are fastened via a lobe-shaped holder to a deformable bar. Due to the lack of a stable mount for the prosthetic teeth, this structure is not suitable for use in a subtractive CAM apparatus, since the prosthetic teeth might change position due to exposure to a force during milling or machining of the prosthetic teeth, meaning that precise machining would no longer be possible. WO 2017/005 905 A1 proposes machining a set of prosthetic teeth which are fixed in a shrink film. The shrink film here has to be removed with the CAM apparatus in those regions in which the prosthetic teeth are to be machined. In this case, in the case of large-area machining of the prosthetic teeth the shrink film may loosen, making the prosthetic teeth movable in their position and orientation, such that precise machining of the prosthetic teeth becomes difficult or even impossible.

The object of the invention thus consists in overcoming the disadvantages of the prior art. In particular, a preliminary product and a method are to be developed with which prosthetic teeth may be machined precisely and with reproducible quality in a CAM apparatus to produce a dental prosthesis without residues of a wax or any other fixative having subsequently to be removed by cleaning. The preliminary product and method are intended to enable rapid, inexpensive manufacture of a dental prosthesis. The preliminary product is intended to be inexpensive to produce and to process when producing dental prostheses. Post-machining of the basally shortened prosthetic teeth manufactured with the preliminary product is intended to be as simple as possible.

The objects of the invention are achieved with a preliminary product for the production of prosthetic teeth of a dental prosthesis, the preliminary product having a plurality of prefabricated prosthetic teeth and a mounting geometry, the prefabricated prosthetic teeth having a preformed coronal surface and a preformed circumferential surface which adjoins the coronal surface, the mounting geometry having at least one strut, wherein the at least one strut is embodied in one piece with at least one of the prefabricated prosthetic teeth, wherein the prefabricated prosthetic teeth are fixable in position with the mounting geometry in a mount of a CAM apparatus in such a way that the prefabricated prosthetic teeth are mechanically machinable with the CAM apparatus.

The circumferential surface of a prosthetic tooth is the surface which surrounds the prosthetic tooth laterally, i.e. on the mesial, distal, approximal, vestibular and lingual sides. If a prosthetic tooth is regarded in a first approximation as an object of circular cylindrical geometry, the cylinder axis of which extends from the dental root to the dental crown, i.e. apical to coronal, then the coronal surface is one of the base surfaces of the cylindrical prosthetic tooth and the circumferential surface is accordingly the cylindrical circumferential surface bounding the base surfaces.

A one-piece embodiment of the at least one strut with at least one prosthetic tooth of the prefabricated prosthetic teeth means that the at least one strut and the at least one prosthetic tooth of the prefabricated prosthetic teeth are manufactured from a consistent material, in particular from a homogeneous consistent material. Connection elements between the at least one strut and the at least one prosthetic tooth of the prefabricated prosthetic teeth are then not present.

According to the invention, the at least one strut preferably takes the form of a general cylinder or is embodied as a film gate. A general cylinder is a cylinder with a circular or indeed a non-circular base. In this case, polygonal cross-sections of the at least one strut are preferred, if individual prosthetic teeth are provided with a mounting geometry, since twist protection is provided by the angular shape of the at least one strut if the at least one strut is used directly to mount and fix the prefabricated prosthetic teeth. A film gate has a linearly extending connection to the at least one prosthetic tooth of the prefabricated prosthetic teeth and may be flat and cuboidal.

In the case of the preliminary product provision may be made for the preliminary product to consist of a plastics material.

Plastics materials are suitable for the production of prosthetic teeth. In addition, plastics materials may be readily machined using automated CAM methods. In addition, the preliminary product, i.e. the prefabricated prosthetic teeth with the mounting geometry, may be simply and inexpensively produced in one piece from plastics material.

In this case, provision may be made for the preliminary product to consist of a tooth-colored plastics material with a Shore hardness (SHORE D hardness) of at least 50, preferably of at least 70.

The Shore hardness is in this case determined to VDI/VDE 2616 (VDI/VDE 2616 Sheet 2 (2014-07): Hardness testing of plastics and elastomers) and to the specifications in DIN standard 53505 (2000).

A Shore hardness (SHORE D hardness) of at least 50, in particular 70, of the plastics material is preferred, because this is then sufficiently hard for use as a material for prosthetic teeth.

Provision may moreover be made for each prosthetic tooth of the prefabricated prosthetic teeth to be embodied connected in one piece to one strut or to two struts or to three struts as the at least one strut.

In this way, it is ensured that all the prosthetic teeth of the prefabricated prosthetic teeth are kept stable by the mounting geometry, such that the prefabricated prosthetic teeth may be held in a defined position and situation during machining with a CAM apparatus, such as a computer-controlled CAM milling machine.

Provision may preferably also be made for the at least one strut of the mounting geometry to be connected to at least one prosthetic tooth of the prefabricated prosthetic teeth at the coronal surface or the circumferential surface or the coronal surface and the circumferential surface of the at least one prosthetic tooth of the prefabricated prosthetic teeth.

Since the at least one strut is intended to hold the prefabricated prosthetic teeth during machining and basal machining is advantageous because the visible surfaces of the at least one prosthetic tooth of the prefabricated prosthetic teeth then require less severe machining and the correct occlusal height must be precisely established, it is sensible not to arrange the at least one strut on the basal side.

In addition, provision may be made for the at least one strut of the mounting geometry to be connected to the at least one prosthetic tooth of the prefabricated prosthetic teeth at the coronal surface or a lingual surface or an approximal surface or a vestibular surface or the coronal surface and/or the lingual surface and/or a distal surface and/or a mesial surface and/or the vestibular surface of the at least one prosthetic tooth of the prefabricated prosthetic teeth.

At these mounting points, the at least one prosthetic tooth of the prefabricated prosthetic teeth or the prefabricated prosthetic teeth may be kept stable. At the same time, the connection at these points may be readily removed inconspicuously with regard to aesthetic appearance.

Provision may also be made, in the case of preferred preliminary products according to the invention, for the mounting geometry to have a frame which encompasses the at least one prosthetic tooth of the prefabricated prosthetic teeth or the prefabricated prosthetic teeth at least in places, wherein the frame is connected via the at least one strut to the at least one prosthetic tooth of the prefabricated prosthetic teeth, wherein preferably the frame is embodied in one piece with the at least one strut and the at least one prosthetic tooth of the prefabricated prosthetic teeth.

The frame enables standardized and stable mounting of the prefabricated prosthetic teeth in a CAM apparatus.

In this case, provision may be made for the frame to surround or enclose each individual prosthetic tooth of the prefabricated prosthetic teeth.

In this way, each prosthetic tooth of the prefabricated prosthetic teeth is kept stable. In this way, the at least one strut may be embodied with a smaller cross-section, without the stable mounting of the prefabricated prosthetic teeth thereby being impaired.

In the case of preliminary products according to the invention, provision may preferably be made for the frame to surround or enclose the circumferential surface of each individual prosthetic tooth of the prefabricated prosthetic teeth.

If the frame surrounds or encloses the circumferential surface of each individual prosthetic tooth of the prefabricated prosthetic teeth, the basal surfaces of the prefabricated prosthetic teeth are readily accessible during machining. This simplifies the subsequent machining. To the same end, preferably all the prosthetic teeth of the prefabricated prosthetic teeth are all identically oriented, such that basal surfaces of all the prosthetic teeth are accessible from the same side of the preliminary product.

It is proposed with the invention that the preliminary product have a plurality of prosthetic teeth.

This gives rise to the possibility of machining a plurality of prosthetic teeth with a CAM apparatus in a single processing step. An entire set of prefabricated prosthetic teeth, for example a quadrant or part of a quadrant or a complete set of teeth, may preferably be preformed with the preliminary product, such that all the prosthetic teeth of a part or complete set of teeth or a contiguous part of a set of teeth may be machined with the CAM apparatus in a single processing step.

In this case, provision may be made for the prefabricated prosthetic teeth to be connected to each other via the at least one strut or for the prefabricated prosthetic teeth to be connected to each other via the at least one strut and a frame.

In this way, no additional mounting means are required, such that the prosthetic teeth connected to each other via the at least one strut provide mutual mounting.

Provision may also be made for all the prosthetic teeth of the prefabricated prosthetic teeth to be identically oriented, wherein basal surfaces of all the prosthetic teeth are accessible from one side of the preliminary product.

In this way, it is ensured that all the prosthetic teeth may readily be basally machined from the same side of the preliminary product.

According to one further development of the present invention, provision may be made for the preliminary product to be produced by filling a casting mold with a plastics material by casting or injection, wherein preferably at least one of the at least one strut is formed by a channel, in particular a runner.

This production method is simple and inexpensive to perform. Furthermore, the at least one strut may thereby at the same time be used as a runner, such that additional runners can be dispensed with. Production of the preliminary product is thereby simplified and inexpensive. Preferably, the casting mold is an injection mold.

Provision may moreover be made for the at least one strut to have a cross-section of at least 1 mm, preferably a cross-section of between 1 mm and 3 mm.

With these cross-sections, stable mounting of the prefabricated prosthetic teeth is possible, while at the same time the contact faces between the at least one strut and the at least one prosthetic tooth are as small as possible in order to keep the necessary post-machining of the prefabricated prosthetic teeth to a minimum. The cross-section of the at least one strut is understood to mean the average length of the straight line which may be laid in a cross-sectional area perpendicular to the at least one strut, wherein the straight lines connect together the edges of the cross-sectional area and pass through the centroid (or center point) of the cross-sectional area.

The objects underlying the present invention are also achieved by a method for the production of a preliminary product according to the invention, characterized by the steps of:

1) providing a casting mold for forming the preliminary product, wherein the casting mold has prosthetic tooth molds as the negative molds for forming the prefabricated prosthetic teeth and wherein the casting mold has at least one channel for feeding the prosthetic tooth molds;

2) injecting or pressing a liquid plastics material into the casting mold, wherein the plastics material flows through the at least one channel into the prosthetic tooth molds, wherein the at least one channel forms the at least one strut;

3) curing the plastics material in the casting mold; and

4) demolding the cured plastics material.

An injection mold for injection molding of the preliminary product is preferably used as the casting mold.

In this case, provision may be made for the prosthetic tooth molds to be connected to each other by in each case at least one of the at least one channel or for the prosthetic tooth molds to be connected to each other via in each case at least one of the at least one channel and via a frame mold of the casting mold, wherein the frame mold is suitable for forming a frame of a preliminary product with a frame.

In this way, the method enables a full set of prosthetic teeth to be produced straight away with the preliminary product, such that the prefabricated prosthetic teeth may be jointly machined in a subsequent step. In addition, the prefabricated prosthetic teeth are all connected stably to each other and thus kept stable during machining.

Provision may furthermore be made for the casting mold to be composed of two or more parts, wherein each of the at least one channel is formed by two parts of the casting mold.

In this way, demolding of the preliminary product may be simplified.

The objects underlying the present invention are also achieved by a method for the production of a dental prosthesis using a CAM method, having the steps of:

A) providing a preliminary product according to the invention or producing a preliminary product using a method according to the invention for the production of a preliminary product according to the invention;

B) fixing the preliminary product in a CAM apparatus;

C) subsequent subtractive machining, in particular shortening of at least one prosthetic tooth of the prefabricated prosthetic teeth using the CAM apparatus in line with an individual virtual model;

D) separating the at least one machined prosthetic tooth from the mounting geometry by severing or breaking the at least one strut, in particular at a surface of the at least one machined prosthetic tooth; and E) inserting and connecting the at least one machined prosthetic tooth to a prosthetic base to produce the dental prosthesis.

With this method, the advantages achieved by the preliminary product are transferred to the dental prosthesis to be produced. The individual virtual model may be kept very simple and for example substantially merely encompass the tooth height of all the prosthetic teeth for the dental prosthesis. The individual virtual model can however also encompass the entire external shape of the prosthetic teeth of the dental prosthesis and optionally also the prosthetic base.

In this case, provision may be made for the at least one prosthetic tooth of the prefabricated prosthetic teeth to be basally shortened in step C) in line with the individual virtual model.

In this way, the occlusal height of the dental prosthesis is adjusted without the occlusal surface of the prefabricated prosthetic teeth having to be shortened, such that the aesthetic appearance and the function of the tooth cusps of the at least one prefabricated prosthetic tooth of the prefabricated prosthetic teeth is not impaired.

Provision may furthermore be made, in step D), for a frame of the preliminary product and/or parts of the at least one strut to be remain connected to the CAM apparatus, while the at least one machined prosthetic tooth is detached or the machined and unmachined prosthetic teeth are detached.

In this way, it is clarified that it is not the prefabricated prosthetic teeth themselves that are clamped in the CAM apparatus but rather these are fixed in the CAM apparatus via the at least one strut or via the mounting geometry.

Provision may moreover be made, after step C), for the mounting geometry, in particular the at least one strut, to be milled, such that a predetermined breaking point arises, wherein the predetermined breaking point is used in step D), which proceeds after step C), to separate the at least one machined prosthetic tooth from the mounting geometry or the machined and unmachined prosthetic teeth from the mounting geometry.

In this way, the machined prosthetic teeth may be removed together with the mounting geometry from the CAM apparatus and the machined prosthetic teeth separated from the mounting geometry by breaking or severing the predetermined breaking points.

Finally, provision may be made for the at least one machined prosthetic tooth still connected to the mounting geometry to be inserted into the prosthetic base after step C) and connected to the prosthetic base, before the at least one machined prosthetic tooth is separated from the mounting geometry or the machined and unmachined prosthetic teeth are separated from the mounting geometry, such that step E) proceeds after step C) and step D) after step E).

In this way, the mounting geometry may additionally be used for correct positioning of the at least one machined prosthetic tooth on connection to the prosthetic base. To this end, it is sensible if the preliminary product is individually manufactured in line with a model, preferably a CAD model, adapted individually to the respective patient, if more than just one prosthetic tooth is present in the preliminary product, since the position and situation of the prosthetic teeth relative to one another are better configured individually. The data or the three-dimensional shapes may optionally be used for this purpose which are used to produce the dental prosthesis to be manufactured.

Underlying the invention is the surprising recognition that the use of struts as mounting geometry or as part of a mounting geometry for prefabricated prosthetic teeth makes it possible to provide a one-piece preliminary product which can be straightforwardly machined using a subtractive CAM method, in particular a material-removing CAM method, without onerous cleaning of the machined prosthetic teeth subsequently being necessary. The preliminary product and the method are in this case simpler and less expensive with regard to production and machining than known preliminary products when used comparably. The tools used for the subtractive CAM method, in particular milling, may be used directly and in the same processing step to separate the at least one strut from the at least one machined prosthetic tooth. Complex post-machining is not necessary. However, the point at which the last one of the at least one strut was connected to the respective prosthetic tooth should be briefly polished or post-machined. The preliminary product may thus be used for simple, quick and inexpensive production of prosthetic teeth adapted to the treatment situation, in particular prosthetic teeth basally shortened to match occlusal height. The preliminary product and the method are in this case also highly suitable for the shortening or machining and production of a plurality of prosthetic teeth for an individual dental prosthesis.

The present invention relates to the production of a mounting geometry on prosthetic teeth of plastics material by injection/pressing on of the mounting geometry, during the manufacturing process, for subsequent clamping of the prosthetic teeth for machining of the prosthetic teeth by a subtractive manufacturing process. The invention relates to one or more injected-on struts (as projections in the form of “mounting pins”) as mounting geometry, which are manufactured together with the prosthetic teeth during the injection molding or pressing process.

The preliminary product according to the invention and the method according to the invention allow simple, secure clamping of the prosthetic teeth with the preliminary product. Other current solutions, on the other hand, are very onerous or rather imprecise. Manufacture of the preliminary product does not result in any additional costs, if the mounting geometry is taken into account at the start when constructing new tooth molds.

The preliminary product according to the invention enables more precise clamping of the prefabricated prosthetic teeth. The preliminary product according to the invention and the method according to the invention for producing a dental prosthesis enable ease of handling and implementation, such that not just centralized but also decentralized manufacture is possible, wherein fewer processing steps are needed than with known methods. The shortened prosthetic teeth are not contaminated with wax, since the prosthetic teeth no longer have to be cast in little frames. This results in process stabilization, since no wax residues can negatively influence the adhesive bond between the prefabricated prosthetic teeth and the prosthetic base. After shortening of the at least one prosthetic tooth of the prefabricated prosthetic teeth, the mounting geometry may be milled, such that a predetermined breaking point arises and the prosthetic teeth can be cemented into the prosthesis without significant additional effort. The mount geometry may optionally also be used as a positioning aid during subsequent adhesive bonding to the prosthetic base.

Further exemplary embodiments of the invention are explained below with reference to eight schematic figures but without thereby limiting the invention. Therein:

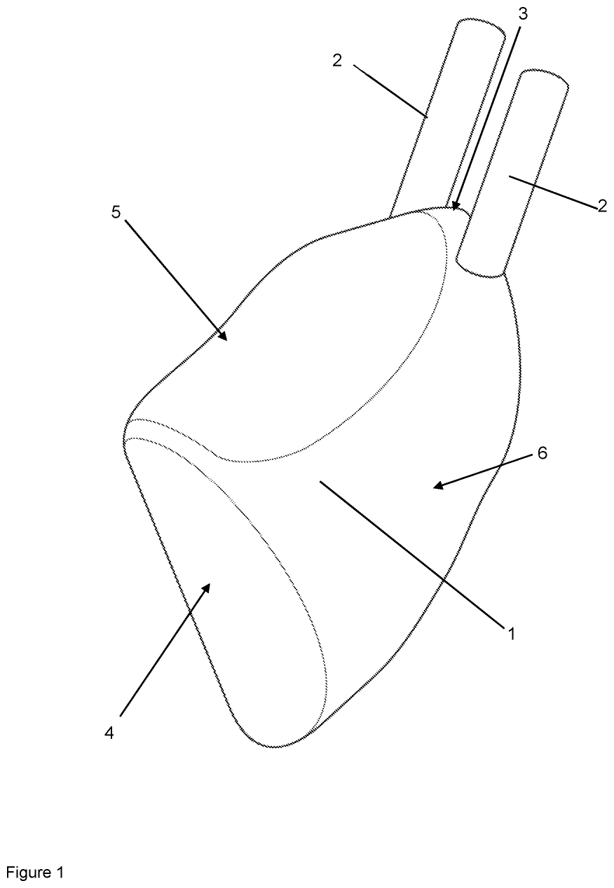

FIG. 1 shows a schematic perspective view of a preliminary product according to the invention for implementation of a method according to the invention and produced using a method according to the invention;

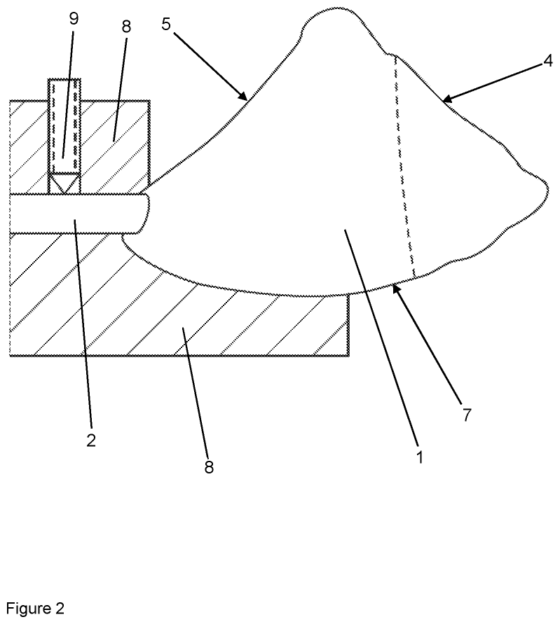

FIG. 2 shows a schematic partially sectional view of the preliminary product according to the invention according to FIG. 1, which is clamped into a mounting apparatus of a CAM apparatus for implementation of a method according to the invention;

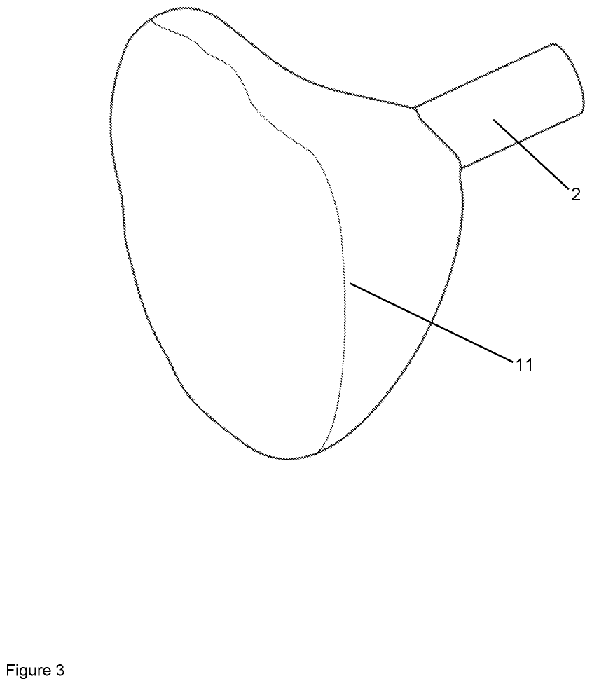

FIG. 3 shows a schematic perspective view of a second alternative preliminary product according to the invention;

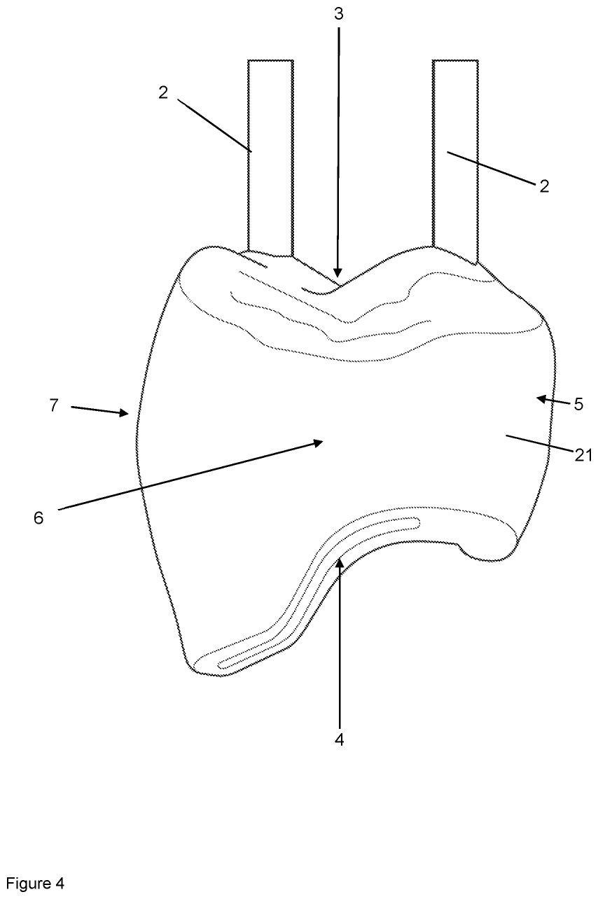

FIG. 4 shows a schematic perspective view of a third alternative preliminary product according to the invention;

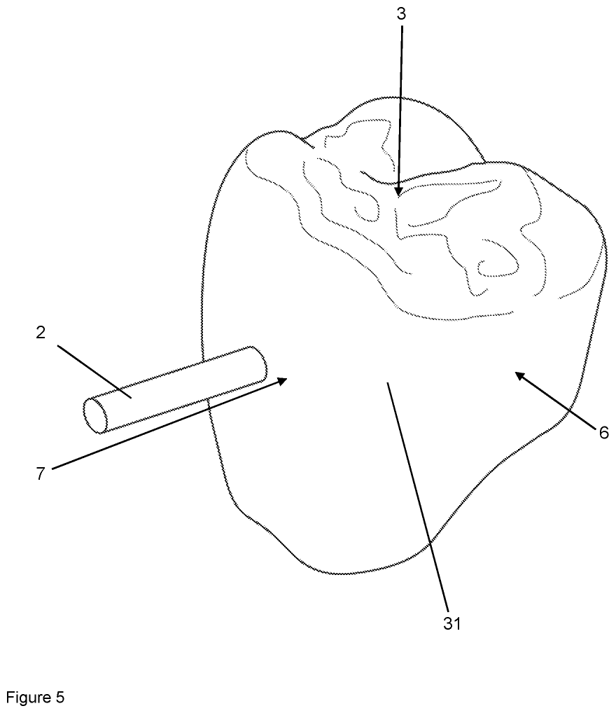

FIG. 5 shows a schematic perspective view of a fourth alternative preliminary product according to the invention;

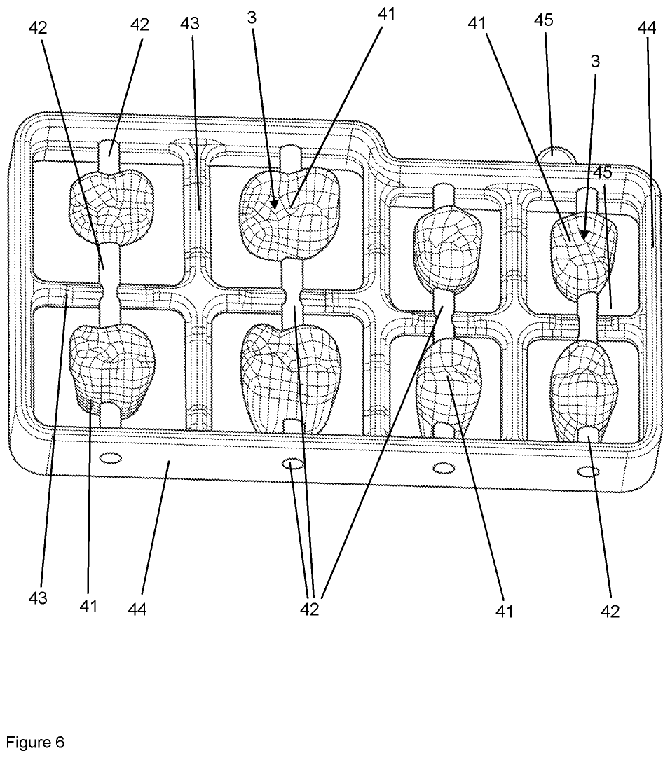

FIG. 6 shows a schematic perspective view of a fifth alternative preliminary product according to the invention for implementation of a method according to the invention and produced using a method according to the invention;

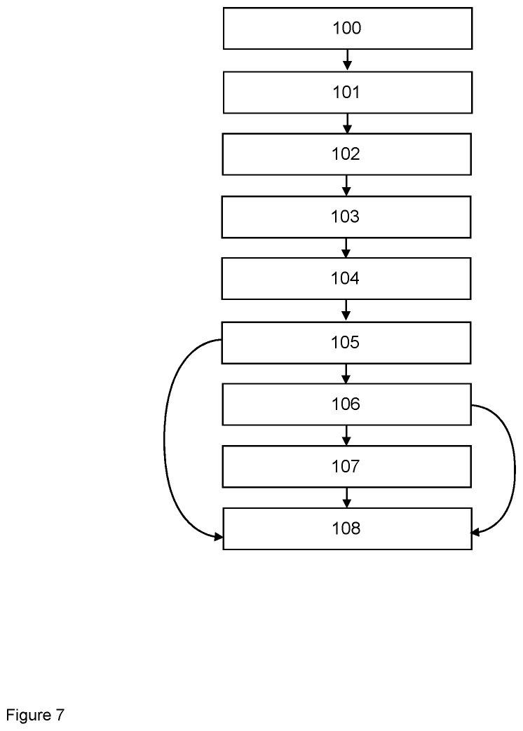

FIG. 7 shows the sequence of a method according to the invention for producing a dental prosthesis of a preliminary product according to the invention; and

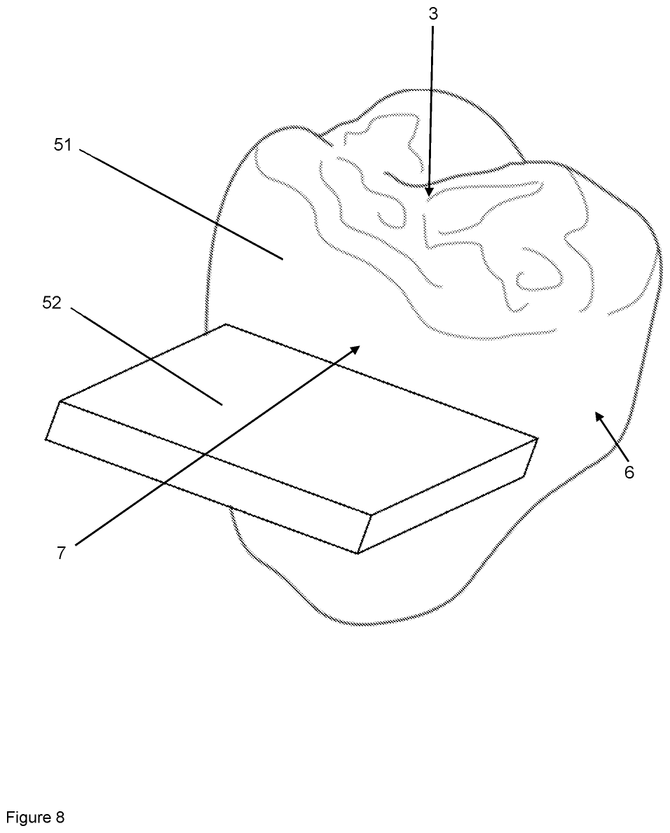

FIG. 8 shows a schematic perspective view of a sixth alternative preliminary product according to the invention.

In the figures, for the sake of clarity, even for different embodiments the same reference signs are sometimes also used for different but similar parts, such as for example for the struts in different embodiments, which are labeled throughout the following description of the figures and in all the figures with the reference sign 2. Likewise, no distinction is made in the various exemplary embodiments with regard to directional designations.

FIG. 1 is a schematic perspective view of a preliminary product according to the invention for implementation of a method according to the invention and produced using a method according to the invention. FIG. 2 is a schematic partially sectional view of the preliminary product according to the invention according to FIG. 1, which is clamped into a mounting apparatus of a CAM apparatus (shown only in part) for implementation of a method according to the invention. FIGS. 1 and 2 show a prosthetic tooth 1 for replacement a canine. Two cylindrical struts 2 are arranged on a coronal surface 3 of the prosthetic tooth 1 on the individual prefabricated prosthetic tooth 1. The prosthetic tooth 1 and the two struts 2 are manufactured in one piece from plastics material. To this end, the plastics material is injected in liquid form into a casting mold as the negative mold (not shown) through two channels, which form the struts 2 once the plastics material in the casting mold has cured. When the preliminary product is mounted using the struts 2, the basal surface 4, the lingual surface 5, the approximal surfaces 6 (or more precisely the mesial and distal surfaces 6) and the vestibular surface 7 of the prosthetic tooth 1 are accessible and may be machined using the CAM apparatus. The mesial, distal, lingual and vestibular surface 5, 6, 7 forms the circumferential surface 5, 6, 7 of the prosthetic tooth 1 which adjoins the coronal surface 3 and the basal surface 4 opposite the coronal surface 3.

To this end, the CAM apparatus has a mounting apparatus 8, into which the struts 2 may be inserted. The struts 2 may be fixed and secured therein with the assistance of a clamping screw 9, such that the preliminary product is fixed in the mounting apparatus 8 and thus the CAM apparatus and can be subtractively machined using a milling head of the CAM apparatus. It is sufficient if, as shown in FIG. 2, the basal surface 4 and the circumferential surface 5, 6, 7 adjacent thereto are accessible. In this way, the prosthetic tooth 1 can be basally machined or shortened, as indicated by the dashed line in FIG. 2. The area to be cut is calculated using a CAD model, such that the basally shortened prosthetic tooth 1 may be connected to a prosthetic base (not shown) and in the process the occlusal height of the prosthetic tooth 1 selected to match the treatment situation or the patient. In addition, at least one further prosthetic tooth which is not shown is also present, for example a further canine.

FIG. 2 is thus a schematic representation of a specific exemplary embodiment of a prosthetic tooth 1 of a preliminary product according to the invention. The prosthetic tooth 1 with the struts 2 as mounting geometry is inserted into the mounting apparatus 8 and clamped with the clamping screw 9. The region to the right of the dashed line (in the basal direction) is removed with the milling head of the CAM apparatus. The mounting apparatus 8 may also be embodied such that the struts 2 are milled at the end of machining, such that the prosthetic tooth 1 can be broken off, or completely severed using the milling machine. In the preliminary product according to the invention, a plurality of such prosthetic teeth 1 are provided which may be separately present.

FIG. 3 is a schematic perspective view of a second alternative preliminary product according to the invention. The preliminary product according to FIG. 3 shows a prosthetic tooth 11 for replacing an incisor, wherein just one cylindrical strut 2 is secured to a lingual surface of the prosthetic tooth 11. The preliminary product shown in FIG. 3 may be clamped with the single strut 2 into a matching mounting apparatus, such as the mounting apparatus 8 according to FIG. 2 and subsequently basally machined. In addition, at least one further prosthetic tooth which is not shown is also present, for example a canine according to FIGS. 1 and 2.

It goes without saying that other preformed and prefabricated prosthetic teeth may also be clamped or fixed into such a CAM apparatus or into such a mounting apparatus 8 of such a CAM apparatus according to FIG. 2. The preliminary products according to FIGS. 4 and 5 are mentioned here by way of example.

FIG. 4 is a schematic perspective view of a third alternative preliminary product according to the invention. The preliminary product according to FIG. 4 shows a prosthetic tooth 21 for replacement of a molar, wherein two cylindrical struts 2 are secured to a coronal surface 3 of the prosthetic tooth 21. A basal surface 4 of the prefabricated prosthetic tooth 21 opposite the coronal surface 3 is thereby freely accessible. However, the lingual surface 5, approximal surface 6 (distal or mesial surface), the second approximal surface, not visible in FIG. 4, which is arranged opposite the approximal surface 6, and the vestibular surface 7 of the prosthetic tooth 21, adjoining the coronal surface 3 and the basal surface 4, are also accessible when the preliminary product has been clamped in a CAM milling machine using the struts 2. In addition, at least one further prosthetic tooth which is not shown is also present, for example two further molars.

FIG. 5 is a schematic perspective view of a fourth alternative preliminary product according to the invention. The preliminary product according to FIG. 5 displays a prosthetic tooth 31 for replacement of a molar, wherein just one cylindrical strut 2 is secured to a vestibular surface 7 of the prosthetic tooth 31. The prosthetic tooth 31 additionally has a coronal surface 3 and a basal surface opposite the coronal surface 3 (not visible in FIG. 5). Adjacent the coronal surface 3 and the basal surface are a lingual surface 5, an approximal surface 6 (more precisely a distal or mesial surface 6), the lingual surface, not visible in FIG. 5, which is arranged opposite the vestibular surface 7, and the second approximal surface (more precisely a distal or mesial surface), likewise not visible in FIG. 5, which is arranged opposite the approximal surface 6. In addition, at least one further prosthetic tooth which is not shown is also present, for example two further molars.

The struts 2 according to FIGS. 1 to 5 may also be embodied with a polygonal cross-section instead of with a round cross-section. The polygonal shape of the struts then serves as twist protection. This is helpful in particular in those embodiments in which just one strut is used as mounting geometry, as shown in FIGS. 3 and 5.

FIG. 6 is a schematic perspective view of a fifth alternative preliminary product according to the invention for implementation of a method according to the invention and produced using a method according to the invention.

The preliminary product has eight different molar and premolar prosthetic teeth 41, which are connected via in each case two cylindrical struts 42 to a frame 42, 43 or to an inner frame 43. The thinner inner frame 43 is connected to a solid outer frame 44. A handle 45 is arranged on the outer frame 44, with which handle the preliminary product may be held, gripped and transported between two fingers. The inner frame 43, the outer frame 44 and the struts 42 form a mounting geometry with which the prosthetic teeth 41 are held in position. The preliminary product may be secured with the outer frame 44 in a CAM milling machine, for basal machining of the prosthetic teeth 41. To this end, the prosthetic teeth 41 are all oriented in the same direction. In FIG. 6, therefore, the view of the prosthetic teeth 41 is onto the coronal sides. In addition, in FIG. 6 the lingual sides (top row) and the vestibular sides (bottom row) of the prosthetic teeth 41 may also be seen. The basal surfaces of the prosthetic teeth 41, opposite the coronal side, are therefore all accessible and machinable from the same side of the preliminary product.

With all the prosthetic teeth 41, the struts 42 are connected in one piece to the lingual and the vestibular surfaces of the prosthetic teeth 41. In each case two prosthetic teeth 41 and the struts 42 connected to these prosthetic teeth 41 are manufactured in one piece from plastics material by injection molding using a common casting mold. The common casting mold has channels for introducing the plastics material, said channels forming the struts 42. These four pairs are then connected to each other by the inner frame 43 and the outer frame 44. To this end, the four pairs consisting of in each case two prosthetic teeth 41 and the struts 42 connected in one piece thereto may be inserted into a frame mold to produce the frame 43, 44. In the frame mold the pairs are then connected to each other and the frame 43, 44 is likewise produced in one piece. The entire preliminary product including the prosthetic teeth 41, the struts 42, the inner frame 43 and the outer frame 44 may however also be manufactured in one piece by injection molding of plastics material in a common injection mold.

In the embodiment according to FIG. 6, a plurality of prosthetic teeth 41 are constructed in a blank with the struts 42 as mounting pins and the frame 43, 44. The struts 42 and the frame 43, 44 form runners for the prosthetic teeth 41. As an alternative to the outer frame 44 embodied with rounded corners, a round frame may also be used if this is better suited to securing to a mounting apparatus of the CAM milling machine with which the preliminary product is subtractively machined or the prosthetic teeth 41 of the preliminary product are basally subtractively machined.

After the basal machining (basal shortening) of the prosthetic teeth 41 with the CAM milling machine, the struts 42 are milled directly next to the prosthetic teeth 41 such that they are very thin at the point of transition to the prosthetic tooth 41 and form predetermined breaking points there. The basally machined prosthetic teeth 41 may then simply be broken out of the frame 43, 44 for cementing in place into a prosthetic base (not shown). Prior to this, the broken faces may be smoothed off again.

As an alternative to the embodiment shown in FIG. 6, full sets of prosthetic teeth for the upper jaw or the lower jaw or an entire set of teeth (32 prosthetic teeth) may also be held in a frame. Likewise, to avoid scrap or stock keeping, a preliminary product with just two prosthetic teeth or three or four or six prosthetic teeth may be used.

In the case also of the prosthetic teeth 1 according to FIGS. 1 to 5 and in the case of the prosthetic tooth 51 according to FIG. 8, a frame 43, 44 may be secured to the struts 2, 52 as in FIG. 6 to hold the respective prosthetic tooth 1, 51 or a plurality of prosthetic teeth 1, 51.

An exemplary method is explained below with reference to the preliminary products of FIGS. 1 to 6 and 8. The sequence of the exemplary method is shown in FIG. 7.

In a first processing step 100 an injection mold (not shown) for producing a dental preliminary product according to any one of FIGS. 1 to 6 is provided. The injection mold has to this end at least one prosthetic tooth mold for forming the surfaces 3, 4, 5, 6, 7 of the prosthetic tooth 1, 11, 21, 31 or the prosthetic teeth 41 and at least one channel for passage of a fluid, such as a liquid plastics material, and for forming the strut(s) 2, 42.

In a subsequent processing step 101, a liquid plastics material is injected, stuffed and/or pressed into the injection mold using suitable injection molding technology. The plastics material is then cured in the injection mold in a processing step 102. Demolding of the preliminary product produced in this way then proceeds in a processing step 103 by opening of the injection mold and separation of the injection mold or of the parts of the injection mold from the preliminary product. The preliminary product may also be deflashed in the process. This is however not actually necessary if the flash of the preliminary product is present only on the struts 2, 42 and the basal surfaces 4 of the prosthetic teeth 1, 11, 21, 31, 41 and optionally on the frame 43, 44 and optionally on the handle 45, since the struts 2, 42 and optionally the frame 43, 44 and the handle are not in any way part of the dental prosthesis to be produced and since the prosthetic teeth 1, 11, 21, 31, 41 are in any event basally machined, flash arranged thereon being capable of or even having to be removed in the process without any effort being involved.

In a subsequent processing step 104 the preliminary product is clamped into a CAM apparatus, such as a computer-controlled CAM milling machine. In line with a virtual model of the shortened prosthetic teeth (not shown) needed for insertion into the prosthetic base for the dental prosthesis, the prosthetic teeth 1, 11, 21, 31, 41 are basally shortened using the CAM apparatus and a material-removing method in a processing step 105, preferably using a computer-controlled CAM milling machine based on a virtual model of the shortened prosthetic teeth.

Then, in a processing step 106 separation of the at least partly basally shortened prosthetic teeth proceeds through separation of the struts 2, 42. Alternatively, the struts 2, 42 may also be milled to produce predetermined breaking points, such that the basally shortened prosthetic teeth may be broken off or pressed out of the struts 2, 42. This is optionally followed by post-machining of the basally shortened prosthetic teeth in a processing step 107.

After post-machining or separation of the basally shortened prosthetic teeth from the remaining mounting geometry 2, 42, 43, 44, a final processing step 108 takes place involving insertion and cementing of the basally shortened prosthetic teeth into a prosthetic base (not shown) for production of the dental prosthesis. After curing of the adhesive, polishing of the dental prosthesis may be performed.

FIG. 8 is a schematic perspective view of a sixth alternative preliminary product according to the invention. The preliminary product according to FIG. 8 shows a prosthetic tooth 51 for replacement of a molar, wherein just one strut 52 in the form of a flat plate cuboidal in places is secured as a film gate to a vestibular surface 7 of the prosthetic tooth 51. In addition, at least one further prosthetic tooth (not shown) is present, which is constructed similarly to the prosthetic tooth 51. The prosthetic tooth 51 additionally has a coronal surface 3 and a basal surface opposite the coronal surface 3 (not visible in FIG. 8). Adjacent the coronal surface 3 and the basal surface are a lingual surface 5, an approximal surface 6 (more precisely a distal or mesial surface 6), the lingual surface, not visible in FIG. 8, which is arranged opposite the vestibular surface 7, and the second approximal surface (more precisely a distal or mesial surface), likewise not visible in FIG. 8, which is arranged opposite the approximal surface 6. The strut 52 in the form of a film gate enables stable, non-rotatable connection to the CAM apparatus with which the prosthetic tooth 52 is machined. In addition, the film gate allows a high material flow of the liquid plastics material to be achieved when producing the prosthetic tooth 51 with a prosthetic tooth mold according to a method according to the invention.

The features of the invention disclosed in the above description, as well as in the claims, figures and exemplary embodiments, may be essential both individually and in any desired combination to realization of the invention in its various embodiments.

### LIST OF REFERENCE SIGNS

1 Prosthetic tooth
2 Strut
3 Coronal surface
4 Basal surface
5 Lingual surface
6 Approximal surface
7 Vestibular surface
8 Mounting apparatus
9 Screw
11, 21 Prosthetic tooth
31, 41 Prosthetic tooth
42 Strut
43 Inner frame
44 Outer frame
45 Handle
51 Prosthetic tooth
52 Strut
100 Processing step: providing an injection mold
101 Processing step: injecting a plastics material into the injection mold
102 Processing step: curing the plastics material
103 Processing step: demolding the preliminary product
104 Processing step: clamping the preliminary product into a CAM apparatus
105 Processing step: basally shortening the prosthetic teeth of the preliminary product
106 Processing step: separating the prosthetic teeth by separating the strut(s)
107 Processing step: post-machining the prosthetic teeth
108 Processing step: inserting and cementing the prosthetic teeth into a prosthetic base

1. A preliminary product for the production of prosthetic teeth for a dental prosthesis, the preliminary product having a plurality of prefabricated prosthetic teeth and a mounting geometry, the prefabricated prosthetic teeth having a preformed coronal surface and a preformed circumferential surface which adjoins the coronal surface, the mounting geometry having at least one strut, wherein the at least one strut is embodied in one piece with at least one of the prefabricated prosthetic teeth, wherein the prefabricated prosthetic teeth are fixable in position with the mounting geometry in a mount of a CAM apparatus in such a way that the prefabricated prosthetic teeth are mechanically machinable with the CAM apparatus.

2. The preliminary product according to claim 1, wherein the preliminary product is manufactured from a plastics material.

3. The preliminary product according to claim 2, wherein the preliminary product is manufactured from a tooth-colored plastics material with a Shore hardness (SHORE D hardness) of at least 50.

4. The preliminary product according to claim 1, wherein each prosthetic tooth of the prefabricated prosthetic teeth is embodied connected in one piece to one strut or to two struts or to three struts as the at least one strut.

5. The preliminary product according to claim 1, wherein the at least one strut of the mounting geometry is connected to the prosthetic teeth at the coronal surface or to the circumferential surface or to the coronal surface and the circumferential surface of at least one prosthetic tooth of the prefabricated prosthetic teeth.

6. The preliminary product according to claim 1, wherein the at least one strut of the mounting geometry is connected to at least one prosthetic tooth of the prefabricated prosthetic teeth (1, 11, 21, 31, 41, 51) at the coronal surface or to a lingual surface or to an approximal surface or to a vestibular surface or to the coronal surface and at least one of the lingual surface, the vestibular surface, a distal surface and a mesial surface of the at least one prosthetic tooth of the prefabricated prosthetic teeth.

7. The preliminary product according to claim 1, wherein the mounting geometry has a frame which encompasses the at least one prosthetic tooth of the prefabricated prosthetic teeth at least in places, wherein the frame is connected via the at least one strut to the at least one prosthetic tooth of the prefabricated prosthetic teeth.

8. The preliminary product according to claim 1, wherein the frame surrounds each individual prosthetic tooth of the prefabricated prosthetic teeth.

9. The preliminary product according to claim 7, wherein the frame surrounds or encloses the circumferential surface of each individual prosthetic tooth of the prefabricated prosthetic teeth.

10. The preliminary product according to claim 1, wherein the prefabricated prosthetic teeth are connected to each other via the at least one strut or the prefabricated prosthetic teeth are connected to each other via the at least one strut and a frame.

11. The preliminary product according to claim 1, wherein all the prosthetic teeth of the prefabricated prosthetic teeth are identically oriented, wherein basal surfaces of all the prosthetic teeth are accessible from one side of the preliminary product.

12. The preliminary product according to claim 1, wherein the preliminary product is produced by filling a casting mold with a plastics material by casting or injection.

13. The preliminary product according to claim 1, wherein the at least one strut has a cross-section of at least 1 mm.

14. A method for the production of a preliminary product according to claim 1, having the steps of:
providing a casting mold for forming the preliminary product, wherein the casting mold has prosthetic tooth molds as negative molds for forming the prefabricated prosthetic teeth and wherein the casting mold has at least one channel for feeding the prosthetic tooth molds;
injecting or pressing a liquid plastics material into the casting mold, wherein the plastics material flows through the at least one channel into the prosthetic tooth molds, wherein the at least one channel forms the at least one strut;
curing the plastics material in the casting mold; and
demolding the cured plastics material.

15. The method according to claim 14, comprising:
connecting the prosthetic tooth molds to each other by in each case at least one of the at least one channel or
connecting the prosthetic tooth molds to each other via in each case at least one of the at least one channel and via a frame mold of the casting mold.

16. The method according to claim 14, wherein the casting mold is composed of two or more parts, wherein each of the at least one channel is formed by two parts of the casting mold.

17. A method for the production of a dental prosthesis using a CAM method, having the steps of:
A) providing or producing a preliminary product according to claim 1;
B) fixing the preliminary product in a CAM apparatus;
C) subsequently subtractive machining at least one prosthetic tooth of the prefabricated prosthetic teeth using the CAM apparatus in line with an individual virtual model;
D) separating the at least one machined prosthetic tooth from the mounting geometry by severing or breaking the at least one strut; and
E) inserting and connecting the at least one machined prosthetic tooth to a prosthetic base to produce the dental prosthesis.

18. The method according to claim 17, comprising basally shortening the at least one prosthetic tooth of the prefabricated prosthetic teeth in step C) in line with the individual virtual model.

19. The method according to claim 17, wherein in step D) a frame of the preliminary product and/or parts of the at least one strut remains connected to the CAM apparatus, while the at least one machined prosthetic tooth is detached or the machined and un-machined prosthetic teeth are detached.

20. The method according to claim 17, comprising after step C) milling the mounting geometry, such that a predetermined breaking point arises, wherein the predetermined breaking point is used in step D), which proceeds after step C), to separate the at least one machined prosthetic tooth from the mounting geometry or the machined and un-machined prosthetic teeth from the mounting geometry.

21. The method according to claim 17, comprising inserting at least one machined prosthetic tooth still connected to the mounting geometry into the prosthetic base after step C) and connected to the prosthetic base, before the at least one machined prosthetic tooth is separated from the mounting geometry or the machined and un-machined prosthetic teeth are separated from the mounting geometry, such that step E) proceeds after step C) and step D) after step E.

22. The preliminary product according to claim 3, wherein the preliminary product is manufactured from a tooth-colored plastics material with a Shore hardness (SHORE D hardness) of at least 70.

23. The preliminary product according to claim 7, wherein the frame is embodied in one piece with the at least one strut and the prefabricated prosthetic teeth.

24. The preliminary product according to claim 23, wherein the preliminary product is produced by filling a casting mold with a plastics material by casting or injection, wherein at least one of the at least one strut is formed by a channel.

25. The preliminary product according to claim 24, wherein the preliminary product is produced by filling a casting mold with a plastics material by casting or injection, wherein the at least one strut formed by a channel is a runner.

26. The preliminary product according to claim 13, wherein the at least one strut has a cross-section of between 1 mm and 3 mm.

27. The method according to claim 15, wherein the casting mold is composed of two or more parts, wherein each of the at least one channel is formed by two parts of the casting mold.

28. The method according to claim 17, wherein in step C the subtractive machining is shortening of the at least one prosthetic tooth and/or in step D) the at least one machined prosthetic tooth is separated from the mounting geometry by severing or breaking the at least one strut at a surface of the at least one machined prosthetic tooth.

29. The method according claim 20, comprising after step C) milling the at least one strut such that a predetermined breaking point arises, wherein the predetermined breaking point is used in step D), which proceeds after step C), to separate the at least one machined prosthetic tooth from the mounting geometry or the machined and un-machined prosthetic teeth from the mounting geometry.
